(19) United States
(12) Patent Application Publication
(10) Pub. No.: US 2026/0304457 A1
(43) Pub. Date: Oct. 1, 2026

(54) ENHANCEMENTS TO BEAM MANAGEMENT

(71) Applicant: Nokia Technologies Oy, Espoo (FI)

(72) Inventors: Halit Murat GÜRSU, Munich (DE); Timo KOSKELA, Oulu (FI); Ali KARIMIDEHKORDI, Munich (DE); Subramanya CHANDRASHEKAR, Bangalore (IN); Panagiotis SPAPIS, Munich (DE); Amaanat ALI, Espoo (FI); Umur KARABULUT, Munich (DE); Srinivasan SELVAGANAPATHY, Bangalore (IN)

(21) Appl. No.: 19/100,918

(22) PCT Filed: Jun. 26, 2023
(86) PCT No.: PCT/EP2023/067315

§ 371 Date: Feb. 3, 2025

(30) Foreign Application Priority Data
Aug. 4, 2022 (IN) 202241044598

(51) Int. Cl. H04W 72/27; H04L 5/00; H04W 72/044; H04W 72/51; H04W 88/08

(52) U.S. Cl. CPC H04W 72/27; H04L 5/0032; H04L 5/0051; H04W 72/046; H04W 72/51; H04W 88/085

(57) ABSTRACT

Described herein is a first network node that supports at least one of central unit control plane (CU-CP) functionality or a layer 3 protocol of a radio access network, comprising: at least one processor; and at least one memory storing instructions that, when executed by the at least one processor, cause the first network node at least to: determine to initiate an inter-cell beam management (ICBM) procedure involving at least a source cell of a second network node that supports at least one of distributed unit (DU) functionality or a layer 2 protocol of the radio access network serving a user equipment (UE) and a target cell of a third network node that supports at least one of the DU functionality or the layer 2 protocol of the radio access network; transmit a first request message to the third network node, wherein the first request message comprises information indicative of a beam of the target cell, and information for configuring the third network node to refrain from transmitting a UE-specific reference signal (RS); and receive a first response message from the third network node, wherein the first response message comprises information indicative of a configuration of the beam for the ICBM procedure and information indicative of the third network node being configured to refrain from transmitting the UE-specific RS.

### TECHNOLOGY

The present disclosure relates to beam management, in particular to enhancements to inter-cell mobility activation mechanisms for resource reservation.

### BACKGROUND

Any discussion of the background art throughout the specification should in no way be considered as an admission that such art is widely known or forms part of common general knowledge in the field.

Broadly speaking, starting with a normal cell topology of a radio communications system like e.g., 5G with e.g., gNBs or the like, a gNB could for example be implemented using at least one DU (Distributed Unit) and CU (Central Unit). FIG. 1 schematically shows an example illustration of a coverage map with 21 (micro) cells (those indicated as circles).

When a UE (User Equipment) moves for example in a direction as shown by the arrow of FIG. 1, it may be possible that the UE travels through different cells which may typically lead to several handovers

Unnecessary handovers and corresponding interruptions as well as signaling overhead should be reduced or avoided, as in some possible cases (e.g., depending on the route) it may lead to a lot of ping-pongs, i.e., handover back and forth between two cells and a lot of additional signaling, including radio resource control (RRC) signaling. In addition, it has been observed that normal topology and coverage of the cells may not be as clear as in FIG. 1 due to reasons like shadowing, buildings, etc., but may sometimes show coverage islands penetrating coverage of other cells. Such a more realistic “real world example” may lead to a even more number of ping-pongs, e.g., due to the existence of cell coverage islands or the like and if the UE travels through or close to these islands. This may even be more and more the case if more and more (narrow) beams are used (e.g., in mmWave radio connections).

Various technologies/techniques have been proposed attempting to address at least some of the above issues. However, some of those conventional techniques may, depending on various circumstances, lead to increased signaling overhead, waste of resources, time delay, or the like.

Thus, there is a need to propose new beam management mechanisms in order to address some or all of the above-illustrated issues, particularly in an efficient, flexible yet reliable manner.

### SUMMARY

In accordance with an aspect of the present disclosure, there is provided a first network node that supports at least one of central unit control plane (CU-CP) functionality or a layer 3 (L3) protocol of a radio access network, comprising:
at least one processor; and
at least one memory storing instructions that, when executed by the at least one processor, cause the first network node at least to:
   determine to initiate an inter-cell beam management (ICBM) procedure involving at least a source cell of a second network node that supports at least one of distributed unit (DU) functionality or a layer 2 (L2) protocol of the radio access network, the source cell serving a user equipment (UE), and a target cell of a third network node that supports at least one of the DU functionality or the layer 2 protocol of the radio access network;
   transmit a first request message to the third network node, wherein the first request message comprises information indicative of a beam of the target cell, and information for configuring the third network node to refrain from transmitting a UE-specific reference signal (RS); and
   receive a first response message from the third network node, wherein the first response message comprises information indicative of a configuration of the beam for the ICBM procedure and information indicative of the third network node being configured to refrain from transmitting the UE-specific RS.

In some examples, the first network node is further caused to:
transmit a second request message to the second network node, wherein the second request message comprises information indicative of the configuration of the beam and information indicative of the third network node being configured to refrain from transmitting the UE-specific RS; and
receive a second response message from the second network node, wherein the second response message comprises information indicative of an acknowledgement for the third network node being configured to refrain from transmitting the UE-specific RS.

In some examples, the second request message further comprises information indicative of requesting transmission of a message indicating a switch of the UE to the beam of the target cell is to be expected; and
the second response message further comprises information indicative of an acknowledgement for the information indicative of requesting transmission of a message indicating a switch of the UE to the beam of the target cell is to be expected.

In some examples, the first network node is further caused to:
receive, from the second network node, a first indication message comprising information indicating that a switch of the UE to the beam of the target cell is to be expected; and
transmit a second indication message to the third network node for enabling the third network to start transmitting the UE-specific RS.

In some examples, the first network node is further caused to:
receive, from the third network node, a third indication message comprising information indicative of transmission of the UE-specific RS; and
transmit a fourth indication message comprising information indicative of the transmission of the UE-specific RS by the third network node.

In some examples, the determination to initiate the ICBM procedure is based on at least one of: a measurement report received from the UE, or a system operation and maintenance configuration.

In some examples, the UE-specific RS comprises a channel state information reference signal (CSI)-RS.

In some examples, each of the source and target cells is configurable to operate in at least one bandwidth part (BWP); and
the first network node is further caused to:
determine that the target cell does not support at least one BWP currently associated with the UE;
transmit a third request message to the third network node, wherein the third request message comprises information indicative of a beam on a BWP of the target cell; and
receive, from the third network node, a third response message comprising information indicative of a BWP configuration for the beam.

In some examples, the first network node is further caused to:
determine whether the UE is capable of supporting more than one BWP simultaneously;
based on determining that the UE is capable of supporting more than one BWP simultaneously:
   transmit a fourth request message to the second network node, wherein the fourth request message comprises information indicative of the BWP configuration for the beam; and
based on determining that the UE is not capable of supporting more than one BWP simultaneously:
   transmit a fifth request message to the second network node, wherein the fifth request message comprises information indicative of the BWP configuration for the beam and information for configuring the second network node to indicate when a switch to the beam of the target DU is to be expected.

In some examples, the first network node is further caused to:
receive, from the second network node, a message comprising information indicative of the switch to the beam of the target DU is to be expected.

In some examples, the first network node is further caused to:
transmit a configuration message comprising information indicative of the BWP configuration for the beam to the UE.

In accordance with another aspect of the present disclosure, there is provided a second network node that supports at least one of distributed unit (DU) functionality or a layer 2 (L2) protocol of a radio access network and is configured with a source cell serving a user equipment (UE), comprising:
at least one processor; and
at least one memory storing instructions that, when executed by the at least one processor, cause the second network node at least to:
   receive, from a first network node that supports at least one of central unit control plane (CU-CP) functionality or a layer 3 (L3) protocol of the radio access network, a first request message comprising information indicative of a configuration for a beam of a target cell of a third network node that supports at least one of the DU functionality or the layer 2 (L2) protocol of the radio access network, and information indicative of the third network node being configured to refrain from transmitting a UE-specific reference signal (RS); and
   transmit a first response message to the first network node, wherein the first response message comprises information indicative of an acknowledgement for the information indicative of the third network node being configured to refrain from transmitting the UE-specific RS.

In some examples, the second network node is further caused to:
determine that a switch of the UE to the beam of the target cell is to be expected; and
transmit a first indication message comprising information indicative of the to be expected switch to the first network node.

In some examples, the second network node is further caused to receive a first measurement report from the UE, wherein the determination that a switch of the UE to the beam of the target cell is to be expected is based on the first measurement report.

In some examples, the second network node is further caused to receive, from the first network node, a second indication message comprising information indicative of transmission of the UE-specific RS by the third network node.

In some examples, the second network node is further caused to:
receive, from the UE, a second measurement report;
determine to switch the UE to the beam of the target cell based on the second measurement report; and
transmit a message comprising information indicative of a transmission configuration indication (TCI) state change corresponding to the target cell to the UE.

In some examples, each of the source and target cells is configurable to operate in at least one bandwidth part (BWP).

In some examples, the second network node is further caused to receive, from the first network node, a second request message comprising information indicative of a BWP configuration for the beam of the target cell.

In some examples, the second network node is further caused to receive, from the first network node, a third request message comprising information indicative of a BWP configuration for the beam of the target cell and information indicative of a configuration for the second network node to indicate when a switch to the beam of the target DU is to be expected.

In some examples, the second network node is further caused to:
determine that a switch to the beam of the target DU is to be expected; and
transmit a third indication message comprising information indicating that the switch to the beam of the target DU is to be expected to the first network node.

In accordance with yet another aspect of the present disclosure, there is provided a third network node that supports at least one of distributed unit (DU) functionality or a layer 2 (L2) protocol of a radio access network, comprising:
at least one processor; and
at least one memory storing instructions that, when executed by the at least one processor, cause the third network node at least to:
   receive, from a first network node that supports at least one of central unit control plane (CU-CP) functionality or a layer 3 (L3) protocol of the radio access network, a first request message comprising information indicative of a beam of a target cell of the third network node, and information for configuring the third network node to refrain from transmitting a UE-specific reference signal (RS);
   configure the third network node to refrain from transmitting UE-specific RS; and
   transmit a first response message to the first network node, wherein the first response message comprises information indicative of the third network node being configured to refrain from transmitting the UE-specific RS.

In some examples, the third network node is further caused to:
receive, from the first network node, a first indication message comprising information indicating that a switch of a user equipment (UE) served by a source cell of a second network node that supports at least one of the DU functionality or the layer 2 protocol of the radio access network to the beam of the target cell is to be expected;
start transmitting the UE-specific RS; and
transmit a second indication message comprising information indicative of an acknowledgement for the to be expected switch to the first network node.

In some examples, the UE-specific RS comprises channel state information (CSI) related RS.

In some examples, the target cells is configurable to operate in at least one bandwidth part (BWP).

In some examples, the third network node is further caused to:
receive, from the first network node, a second request message comprising information indicative of a beam on a BWP of the target cell; and
transmit a second response message comprising information indicative of a BWP configuration for the beam to the first network node.

In accordance with another aspect of the present disclosure, there is provided a user equipment (UE), comprising:
at least one processor; and
at least one memory storing instructions that, when executed by the at least one processor, cause the UE at least to:
   receive, from a first network node that supports at least one of central unit control plane (CU-CP) functionality or a layer 3 protocol of the radio access network, a configuration message comprising information indicative of a beam of a target cell of a third network node that supports at least one of distributed unit (DU) functionality or a layer 2 protocol of the radio access network, and information indicative of the third network node being configured to refrain from transmitting a UE-specific reference signal (RS);
   monitor the UE-specific RS; and
   based on determining that the UE-specific RS is broadcast, transmit a message comprising information indicative of the UE-specific RS being broadcast to a second network node that supports at least one of the DU functionality or the layer 2 protocol of the radio access network.

In accordance with another aspect of the present disclosure, there is provided a system, comprising:
a second network node that supports at least one of distributed unit (DU) functionality or a layer 2 protocol of a radio access network as disclosed in the present disclosure; and
a user equipment (UE) served by a source cell of the second network node.

In accordance with another aspect of the present disclosure, there is provided a first network node that supports at least one of central unit control plane (CU-CP) functionality or a layer 3 (L3) protocol of a radio access network, comprising:
at least one processor; and
at least one memory storing instructions that, when executed by the at least one processor, cause the first network node at least to:
   determine to initiate an inter-cell beam management (ICBM) procedure involving at least a source cell of a second network node that supports at least one of distributed unit (DU) functionality or a layer 2 (L2) protocol of the radio access network, the source cell serving a user equipment (UE) and a target cell of a third network node that supports at least one of the DU functionality or the layer 2 protocol of the radio access network;
   determine that the target cell does not support at least one BWP currently associated with the UE;
   transmit a request message to the third network node, wherein the request message comprises information indicative of a beam on a BWP of the target cell; and
   receive, from the third network node, a response message comprising information indicative of a BWP configuration for the beam.

In accordance with another aspect of the present disclosure, there is provided a second network node that supports at least one of distributed unit (DU) functionality or a layer 2 (L2) protocol of a radio access network and is configured with a source cell serving a user equipment (UE), comprising:
at least one processor; and
at least one memory storing instructions that, when executed by the at least one processor, cause the second network node at least to:
   receive, from a first network node that supports at least one of central unit control plane, CU-CP, functionality or a layer 3 protocol of the radio access network, a request message comprising information indicative of a BWP configuration for a beam of a target cell of a third network node that supports at least one of the DU functionality or the layer 2 protocol of the radio access network; or
   receive, from the first network node, a request message comprising information indicative of a BWP configuration for the beam of the target cell and information indicative of a configuration for the second network to indicate to the first network node when a switch to the beam of the target cell is to be expected.

In accordance with yet another aspect of the present disclosure, there is provided a third network node that supports at least one of distributed unit (DU) functionality or a layer 2 (L2) protocol of a radio access network, comprising:
at least one processor; and
at least one memory storing instructions that, when executed by the at least one processor, cause the third network node at least to:
   receive, from a first network node that supports at least one of central unit control plane, CU-CP, functionality or a layer 3 protocol of the radio access network, a request message comprising information indicative of a beam on a BWP of a target cell of the third network node; and
   transmit a response message to the first network node, wherein the response message comprises information indicative of a BWP configuration for the beam.

In accordance with yet another aspect of the present disclosure, there is provided a method of a first network node that supports at least one of central unit control plane (CU-CP) functionality or a layer 3 (L3) protocol of a radio access network, the method comprising:
determining to initiate an inter-cell beam management (ICBM) procedure involving at least a source cell of a second network node that supports at least one of distributed unit (DU) functionality or a layer 2 (L2) protocol of the radio access network, the source cell serving a user equipment (UE) and a target cell of a third network node that supports at least one of the DU functionality or the layer 2 protocol of the radio access network;
transmitting a first request message to the third network node, wherein the first request message comprises information indicative of a beam of the target cell, and information for configuring the third network node to refrain from transmitting a UE-specific reference signal (RS); and
receiving a first response message from the third network node, wherein the first response message comprises information indicative of a configuration of the beam for the ICBM procedure and information indicative of the third network node being configured to refrain from transmitting the UE-specific RS.

In accordance with yet another aspect of the present disclosure, there is provided a method of a second network node that supports at least one of distributed unit (DU) functionality or a layer 2 (L2) protocol of a radio access network and is configured with a source cell serving a user equipment (UE), the method comprising:
receiving, from a first network node that supports at least one of central unit control plane (CU-CP) functionality or a layer 3 (L3) protocol of the radio access network, a first request message comprising information indicative of a configuration for a beam of a target cell of a third network node that supports at least one of the DU functionality or the layer 2 (L2) protocol of the radio access network, and information indicative of the third network node being configured to refrain from a transmitting UE-specific reference signal (RS); and
transmit a first response message to the first network node, wherein the first response message comprises information indicative of an acknowledgement for the information indicative of the third network node being configured to refrain from transmitting the UE-specific RS.

In accordance with yet another aspect of the present disclosure, there is provided a method of a third network node that supports at least one of distributed unit (DU) functionality or a layer 2 (L2) protocol of a radio access network, the method comprising:
receiving, from a first network node that supports at least one of central unit control plane (CU-CP) functionality or a layer 3 (L3) protocol of the radio access network, a first request message comprising information indicative of a beam of a target cell of the third network node, and information for configuring the third network node to refrain from transmitting a UE-specific reference signal (RS);
configuring the third network node to refrain from transmitting UE-specific RS; and
transmitting a first response message to the first network node, wherein the first response message comprises information indicative of the third network node being configured to refrain from transmitting the UE-specific RS.

In accordance with yet another aspect of the present disclosure, there is provided a method of a first network node that supports at least one of central unit control plane (CU-CP) functionality or a layer 3 (L3) protocol of a radio access network, the method comprising:
determining to initiate an inter-cell beam management (ICBM) procedure involving at least a source cell of a second network node that supports at least one of distributed unit (DU) functionality or a layer 2 protocol of the radio access network, the source cell serving a user equipment (UE) and a target cell of a third network node that supports at least one of the DU functionality or the layer 2 protocol of the radio access network;
determining that the target cell does not support at least one BWP currently associated with the UE;
transmit a request message to the third network node, wherein the request message comprises information indicative of a beam on a BWP of the target cell; and
receiving, from the third network node, a response message comprising information indicative of a BWP configuration for the beam.

In accordance with yet another aspect of the present disclosure, there is provided a method of a second network node that supports at least one of distributed unit (DU) functionality or a layer 2 (L2) protocol of a radio access network and is configured with a source cell serving a user equipment (UE), the method comprising:
receiving, from a first network node that supports at least one of central unit control plane, CU-CP, functionality or a layer 3 protocol of the radio access network, a request message comprising information indicative of a BWP configuration for a beam of a target cell of a third network node that supports at least one of the DU functionality or the layer 2 protocol of the radio access network; or
receiving, from the first network node, a request message comprising information indicative of a BWP configuration for the beam of the target cell and information indicative of a configuration for the second network to indicate to the first network node when a switch to the beam of the target cell is to be expected.

In accordance with yet another aspect of the present disclosure, there is provided a method of a third network node that supports at least one of distributed unit (DU) functionality or a layer 2 (L2) protocol of a radio access network, the method comprising:
receiving, from a first network node that supports at least one of central unit control plane, CU-CP, functionality or a layer 3 protocol of the radio access network, a request message comprising information indicative of a beam on a BWP of a target cell of the third network node; and
transmit a response message to the first network node, wherein the response message comprises information indicative of a BWP configuration for the beam.

According to some example embodiments, there is also provided a computer program comprising instructions for causing an apparatus to perform the method as disclosed in the present disclosure.

According to some example embodiments, there is also provided a memory storing computer readable instructions for causing an apparatus to perform the method as disclosed in the present disclosure.

Furthermore, according to some example embodiments, there is provided a first network node that supports at least one of central unit control plane (CU-CP) functionality or a layer 3 (L3) protocol of a radio access network, comprising respective suitable means configured for performing the respective steps as disclosed in the present disclosure.

Similarly, according to some example embodiments, there is also provided a second network node and a third network node that support at least one of distributed unit (DU) functionality or a layer 2 (L2) protocol of a radio access network, comprising respective suitable means configured for performing the respective steps as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of an illustration of a cell coverage map;

FIG. 2 schematically illustrates an example of a signaling/messaging flowchart according to an example embodiment of the present disclosure;

FIG. 3 schematically illustrates an example of a signaling/messaging flowchart according to another example embodiment of the present disclosure;

FIG. 4 schematically illustrates an example of a signaling/messaging flowchart according to another example embodiment of the present disclosure; and

FIG. 5 schematically illustrates an example of a signaling/messaging flowchart according to yet another example embodiment of the present disclosure.

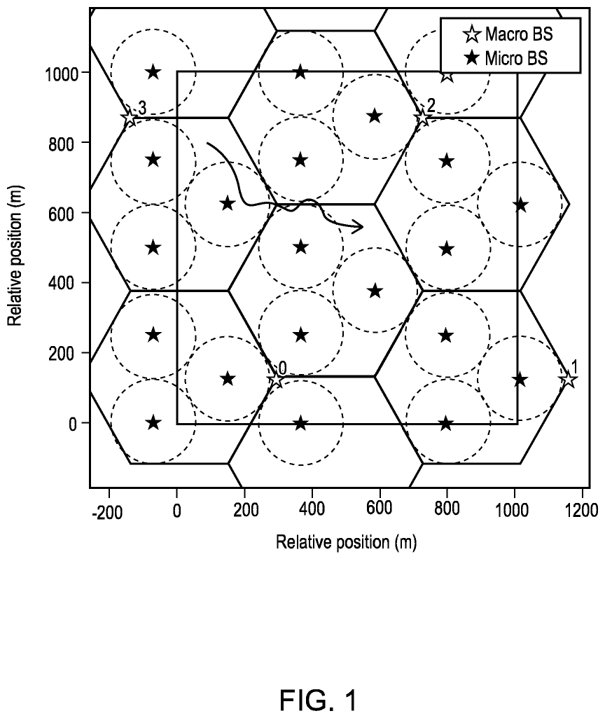

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-June) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the El interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the El interface connected with the gNB-CU-CP and the F1-U interface connected with the gNB-DU, e.g., according to 3GPP TS 38.401 V16.6.0 (2021 -July) section 3.1 incorporated by reference.

Different functional splits between the central and distributed unit are possible, e.g., called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.
Or else, e.g., according to 3GPP TR 38.801 V14.0.0 (2017 -March) section 11 incorporated by reference.

A gNB supports different protocol layers, e.g., Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L 3) includes e.g., Radio Resource Control (RRC), e.g., according to 3GPP TS 38.300 V16.6.0 (2021-June) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-June) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may be omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

As illustrated above, in order to address the problems of signaling overhead, interruption and/or delay (caused by for example unnecessary back-and-forth handover), it is known to make use of a so-called “borrowed” beam of a (target) cell different from the source/serving cell. The (target) cell may be of (operated by) the same serving DU of the source/serving cell or a different DU other than the serving DU, which may thus, in some cases, be referred to as intra-DU ICBM or inter-DU ICBM, respectively. In some possible cases, a UE may be connected to a serving DU, and while traveling through the cell, it may experience good measurement results from another cell (e.g., of another DU) which may be a coverage island inside the serving cell or an overlapping area with a serving cell (e.g., at serving cell edge). The connection with the serving cell may for example be still good, but the connection to the other cell is/becomes better. In that case, UE may be served by the borrowed beam (“borrowed” in the sense that UE may be indicted to communicate with a beam from another cell without the serving cell change) of the non-serving DU without performing a complete (conventional) handover to another cell, and hence no additional RRC signaling overhead and interruption time compared to the (conventional) handover procedure are observed.

However, according to a broad sense, there may be two issues related to such ICBM operations.

Firstly, in some possible scenarios, the neighbor cell may configure a beam (e.g., a finer CSI-RS beam associated with a parent synchronization signal block (SSB) beam and the association may be indicated by the network) that is not broadcasted but is configured to the UE via dedicated signaling. In other words, said beam may be configured to be not scheduled for transmission of the RSs. Therefore, transmitting UE-specific beam (DL reference signals) before the UE switches to that beam would be considered wasting network resources of the non-serving DU and causing extra energy waste (as until UE would be switched by the DU to that beam, UE is not using that beam) and needs to be avoided.

Secondly, in some possible scenarios, the target DU may not support any of the bandwidth parts (BWPs) configurable by the source DU (which might be the base scenario for inter-frequency lower layer mobility (LLM) scenario). As a result, in scenarios where the target DU configures a BWP that the CU cannot configure to the UE, the ICBM operation cannot be supported.

In view thereof, the present disclosure generally proposes apparatuses (such as DU, CU, or the like) as well as corresponding methods to address some or all of the above-illustrated issues/remarks, particularly in an efficient and flexible manner. Particularly, in a broad sense, it may be seen that the present disclosure generally seeks to propose solutions to extend the LLM concepts, namely ICBM, dynamic switching, and L1 based serving cell change, to the inter-DU scenario where the BWP of the source cell cannot be allocated (as assumed in intra-DU ICBM) or it is unnecessary to broadcast neighbor cell resources. In particular, as will become apparent in view of the detailed description below, the present disclosure generally attempts to, among others, specify the information that has to be exchanged between RAN nodes (such as serving DU, CU-CP and target DU) to be able to initiate and prepare the inter-DU procedures.

References are now made to the figures. In particular, it is to be noted that identical or like reference numbers used in the figures of the present disclosure may, unless indicated otherwise, indicate identical or like elements, such that repeated description thereof may be omitted for reasons of conciseness. It is further to be noted that, as can be understood and appreciated by the skilled person, even though the figures may appear to make reference to some specific/explicit message names/types, these messages may certainly, depending on various implementations (e.g., the underlining technologies), have different names and/or be communicated/exchanged in different forms/formats.

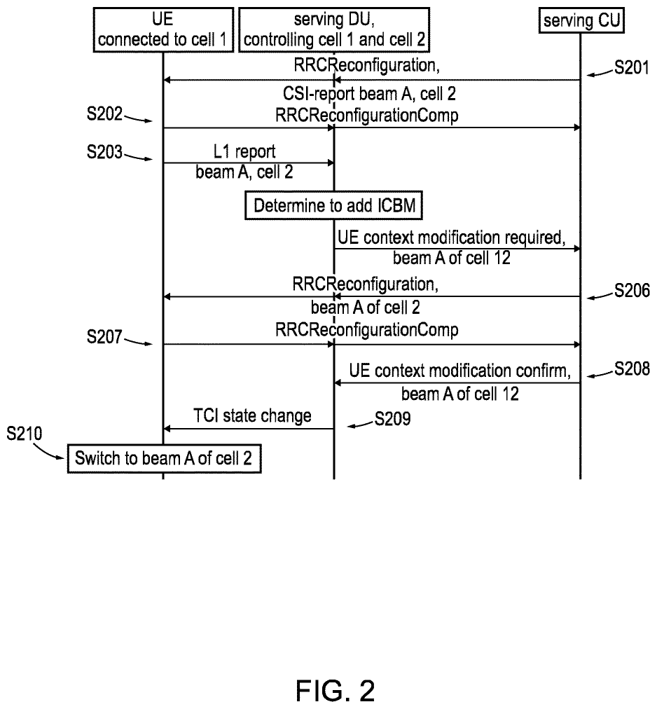

In particular, FIG. 2 schematically illustrates an example of a signaling/messaging flowchart for an exemplary intra-DU ICBM procedure according to example embodiments of the present disclosure. As illustrated above, in intra-DU ICBM scenarios, both the source and target cells (referred to as cell 1 and cell 2 respectively in FIG. 2) are under the control of the same serving (source) DU. It is also generally assumed that, in the example embodiment of FIG. 2, before the method start, the UE is connected to cell 1 (i.e., the source/serving) and does not have an active inter-cell beam management configuration enabled.

Now, in step S201, the CU configures the UE with L1 measurements for a beam A of the neighbor cell 2 (i.e., the target set) for example through an RRC Reconfiguration message (or by using any other suitable message). It is to be noted that, although a single beam A is used as a reference in the example embodiment of FIG. 2, the skilled person would understand and appreciate that, in some other possible implementations, more than one beam may be configured for measurement. In addition, as can also be understood and appreciated by the skilled person, the CU may also configure the UE with a suitable measurement gap, in case the target DU might operate in another bandwidth part (BWP) than the current BWP of the UE (that is in communication with the serving DU). The UE may respond to such configuration for example by sending a corresponding RRCReconfigurationComp message (or the like) to the serving CU, as exemplarily shown in step S202.

Subsequently in step S203, the UE reports L1 measurements (e.g., reference signal received power (RSRP) or the like) for beam A of cell 2 to the DU.

The DU may observe the quality of beam A of cell 2 and determine, in step S204, that the UE may benefit from radio robustness to initiate the ICBM procedure and correspondingly includes said beam A of cell 2 for the beam management operation of the UE.

In step S205, the DU may indicate the beam A of cell 2 to be included in the beam management operation of the UE, e.g., by sending a UE context modification request message (or similar) to the CU. In response thereto, the CU may configure the UE with the beam management information provided by the DU, for example by transmitting another RRCReconfiguration message (or the like) as exemplified in step S206. Upon receipt of a corresponding RRCReconfigurationComp message (or the like) from the UE (step S207), the CU may in turn indicate or acknowledge the successful completion of the UE configuration to the DU, for example by transmitting a corresponding UE context modification confirmation/completion message (or the like) in step S208.

The DU may then, in step S209, send a TCI state change message (e.g., as part of a MAC control element (CE) or in any other suitable form) to activate the beam A of cell 2 for the UE, which may, upon receipt of such TCI state information, switch its operation to the beam A of cell (as indicated by the TCI state change message) as shown in step S210.

Notably, as mentioned above, the inter-cell beam management procedure is to be understood as not being aimed to merely provide mobility-related functionality (e.g., switching, handover, etc.) to different cells but is rather used to provide an enhanced radio coverage to the UE as a temporary solution in order to avoid subsequent (sometimes unnecessary back-and-forth) handovers.

However, in some cases, the general framework of intra-DU ICBM as illustrated above may be considered to not help much in view of cell coverage islands, for example for reasons like that it has been observed that those cell coverage islands may typically be caused by lack of coverage of other Dus than the serving one.

In view thereof, in a broad aspect, the present disclosure generally seeks to propose techniques that enable the CU to trigger (inter-DU) ICBM with cells under the control of a target DU that is different than the source DU. This allows the UE to establish the ICBM operation to inter-DU cells, thereby extending the coverage of ICBM operation to a broader use-case. In this way, the UE can dynamically switch the data connection back and forth from different Dus while keeping the control connection with the serving cell, which is generally considered to be faster than normal inter-DU handover and also reduce signaling overhead, in particular in ping-pong cases. In some possible cases, as the control signaling generally requires much less data rate compared to data transmission, the control connection can also be kept in case of a less good connection to the serving cell. Further, Ues with the capability to transmit/receive on more than one BWPs simultaneously are enabled to use ICBM even if the source and target Dus do not have a common BWP available. Thereby, waste of resources (e.g., prepared, but not used, or not immediately used (e.g., used with delay)) is reduced, e.g., in cases where the CSI-RS has been prepared by the target DU, but the switch to the target DU eventually does not happen.

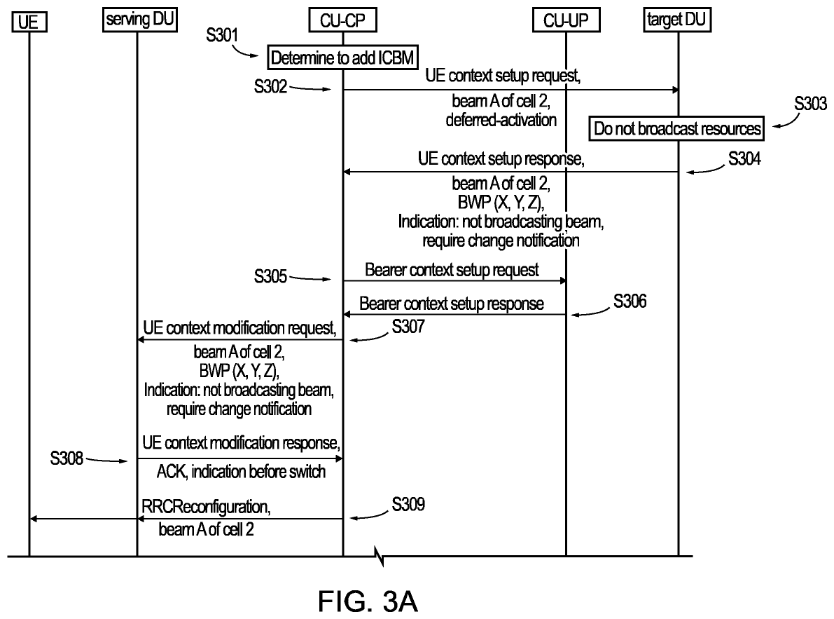

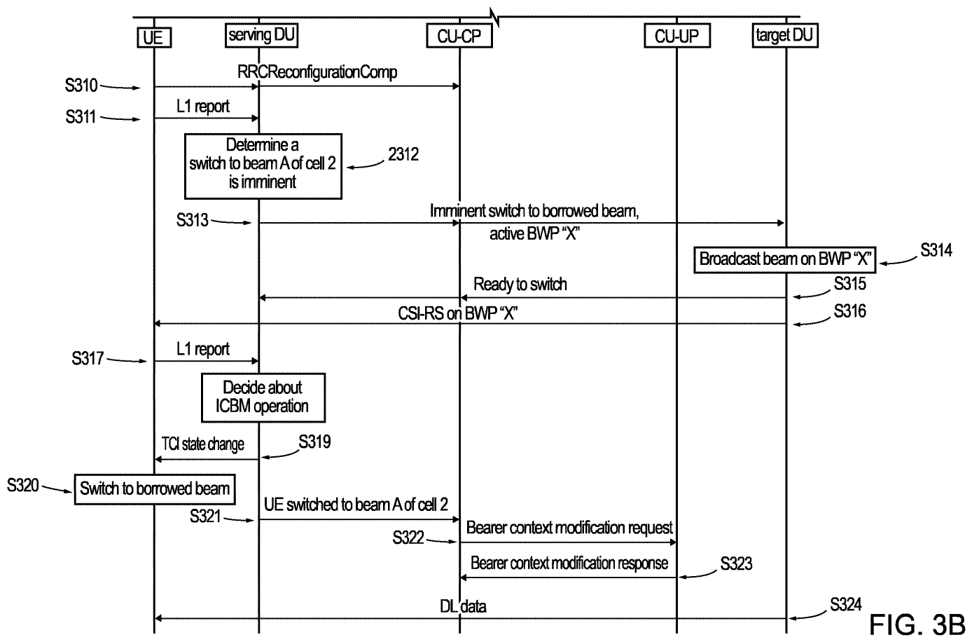

FIG. 3 schematically illustrates an example of a signaling/messaging flowchart according to example embodiments of the present disclosure, and more particularly, shows how the (inter-DU) ICBM configuration could be set up at the target DU based on UE measurements and how the ICBM configuration could be aligned across the source and target Dus. It is to be noted that, in the example embodiment as shown in FIG. 3, it is generally assumed that the source/serving cell (though not explicitly shown in the figure) resides at the source/serving DU (or in other words, under the control of the source/serving DU), whilst the (neighboring) target cell resides at the target DU (or in other words, under the control of the target DU).

Similar to the example embodiment as shown in FIG. 2, before the message flow starts and though not explicitly shown in the figure, it is generally assumed that UE has already established a connection to the serving/source cell of the serving/source DU. In addition, the CU may already configure the UE to report measurements of a beam of the neighbor (target) cell controlled by the target DU. And in response, UE may also acknowledge the measurement configuration and start sending measurement reports of the beam of the neighbor cell (e.g., to the CU via the source DU).

Now as shown in FIG. 3, in step S301, the CU (or more specifically, the CU-CP) may determine to initiate the ICBM procedure for the cell of the target DU. Hereby, CU may send for example a UE context modification request (or any other suitable message, for example in order to request a modification of the (previous/earlier) UE configuration) to the serving DU as exemplified in step S307. Notably, the determination of the initiation of the ICBM procedure may be based on any suitable criteria. As an (non-limiting) example, such determination may be based on the received UE measurements of the beam of the target DU. As another (non-limiting) example, such determination may also be based on operation and maintenance configuration where the beam topology may already be known to the operator such that a RAN node would know the neighbor beam.

In step S302, the CU sends a UE context setup request (or any other suitable message, for example in order to request a setup or creation of a UE context/configuration) to the target DU and indicates that this is for ICBM (e.g., by using a predetermined or predefined field/flag such as the “deferred-activation” as exemplified in step S302). Of course, as can be understood and appreciated by the skilled person, any other suitable means (e.g., in various names, forms, etc.) may be used here for conveying the information indicative of ICBM.

On receipt of such indication (e.g., the “deferred-activation” indication as shown in step S302), the target DU may determine, in step S303, that the allocated beam to the UE is for example a “refined” beam and will not be broadcast (i.e., may not transmit CSI-RS resources associated to specific SSB), in order to not waste radio resources for transmission, for example because there are generally no other Ues using that refined beam (e.g., there may not be any other Ues in the coverage area of an SSB that is used as a source beam for the CSI-RS transmission) in the cell. Notably, the determination of such “refined” beam (and as a result, not to broadcast or schedule UE-specific CSI-RS) may be determined for example based on various criteria such as UE requirements, UE capability to receive a refined beam without extra overhead, UE measurement results that indicate a radio resource efficient transmission is possible, or any other suitable criteria, as can be understood and appreciated by the skilled person.

Subsequently, in step S304 the target DU indicates (e.g., by transmitting a suitable message) that it is not broadcasting the beam allocated to the UE and that the target DU would need an indication to start (or activate) transmission. This indication may be sent along with the UE context setup response, as well as the beam configuration related to the ICBM operation, as exemplified in step S304.

In steps S305-S306, the CU-CP may also interact with the CU-UP for example to perform a suitable bearer set up, as can be understood and appreciated by the skilled person.

Further, the CU indicates, in step S307, the acquired beam configuration from the target DU to the serving DU. Particularly, the CU may specifically indicate that the target DU needs an indication (for example, predetermined or preconfigured) for transmitting the UE beam. In response, the serving DU may acknowledge such indication and provide the beam management configuration for the UE with the beam of cell 2 (the target cell) in step S308.

In steps S309-S310, the CU may configure the UE with the corresponding necessary ICBM configuration (e.g., by sending an RRC Reconfiguration message or the like); and in turn, the UE may acknowledge such configuration (e.g., by sending an RRC Reconfiguration Complete message or the like), as can be understood and appreciated by the skilled person.

After some time, if the assigned beam is still suitable for ICBM based on the UE measurement (step S311), in step S312, the serving DU may determine (e.g., responsive to receiving L1 measurements that may include target SSB measurements from the UE as exemplified in step S311) to switch to the beam of the target cell. For instance, the serving DU may determine, based on the L1 measurement results, that a switch to the beam A of cell 2 is imminent. In step S313, the serving DU indicates this to the CU, which further propagates such indication (in the same of different messages) to the target DU.

Upon receipt of the indication, the target DU may determine in step S314 to start broadcasting the UE specific beam (e.g., CSI-RS) as a response to this indication. In addition, the target DU may also acknowledge this indication to the CU and further to source DU, for example as exemplified by using the expression “Ready to switch” (or in any other suitable manner, such as an indication message) in step S315. In some possible implementations, this indication can also be used by the CU to already start (early) data (e.g., downlink data to the UE) forwarding towards the target DU.

Subsequently, the UE may, in step S316, start receiving the CSI-RS beams broadcast from (scheduled by) the target DU; and report the reception of the CSI-RS beams from the target DU to the source DU in step S317.

Responsive to the measurement(s), the source DU may determine, in step S318, to switch the UE to the beam of the target DU. Notably, such determination may be based on several L1 measurements, for example to ensure that the signal strength of the beam A in the target cell is constant (or constantly better than that of the source beam).

As a result, the source DU triggers the TCI state switch to the UE for example by transmitting a suitable message (step S319) and also indicates the switch to the CU-CP (step S321). In response to such TCI state change indication, the UE may switch to the “borrowed” beam A from the target cell in step S320. Moreover, similar to steps S305 and S306, the CU-CP may contact the CU-UP to complete the bearer context modification.

Finally, the user plane data may be transmitted from the target DU and received by the UE, as shown in step S324.

To summarize the above, the example embodiment as described above with reference to FIG. 3 may generally be seen as to propose to configure the UE with an ICBM operation where the target DU refrains from broadcasting the beam related to the ICBM operation. Whenever the beam of the target cell is to be used for ICBM operation, the source DU (through the CU) indicates the imminent ICBM operation to target DU. The target DU can then use this information to activate broadcasting the related beam accordingly.

The term “the target DU refrains from broadcasting” shall mean that the target DU will not immediately broadcast but is configured or prepared for the broadcast and waits until it receives another signal that triggers the actual broadcast, i.e. the activation of the broadcast is deferred until the trigger is received. Thus, the target DU is configured for a conditional broadcast that requires a trigger in order to be actuated. Examples of the trigger condition are receipt of a change notification, or an activation message sent by the serving DU or the CU-CP. The conditional broadcast may be considered as delayed broadcast, prepared but not send until a condition is met. The same concept of deferred activation holds for “refraining from transmission of a UE-specific reference signal”.

In some possible implementations, the source cell (DU) as well as the target cell (DU) may be configured with one or more BWPs. In such cases, when preparing the target cell for the ICBM operation, the CSI-RS resources for all BWP may be configured at the target cell in the “deactivated” state. Subsequently, whenever BWP switching is triggered at the source DU, the source DU may indicate activation of all the beams corresponding to the given BWP, for example by giving only the BWP ID (or by any other suitable means) towards the target DU. In this case, multiple beams of the given BWP could be activated at the same time via a single message from source DU. Notably, this is also schematically reflected in the example of FIG. 3. To be more specific, as shown in FIG. 3, when the target DU transmits the indication that it is not broadcasting the beam allocated to the UE and that it would need an indication to start the transmission in step S304, the target DU may as well transmit the beam configuration related to the ICBM operation for all relevant BWPs (denoted as “BWP (X, Y, Z)” in step S304). This beam configuration for all BWPs X, Y and Z is also propagated to the serving DU in step S307. Later, as shown in step S313, the source DU may determine to activate only BWP X (e.g., by indicating the BWP ID X to the target DU, as illustrated above). In response to such indication, the target DU may in turn start broadcasting the CSI-RS only on BWP X, as exemplified in step S316.

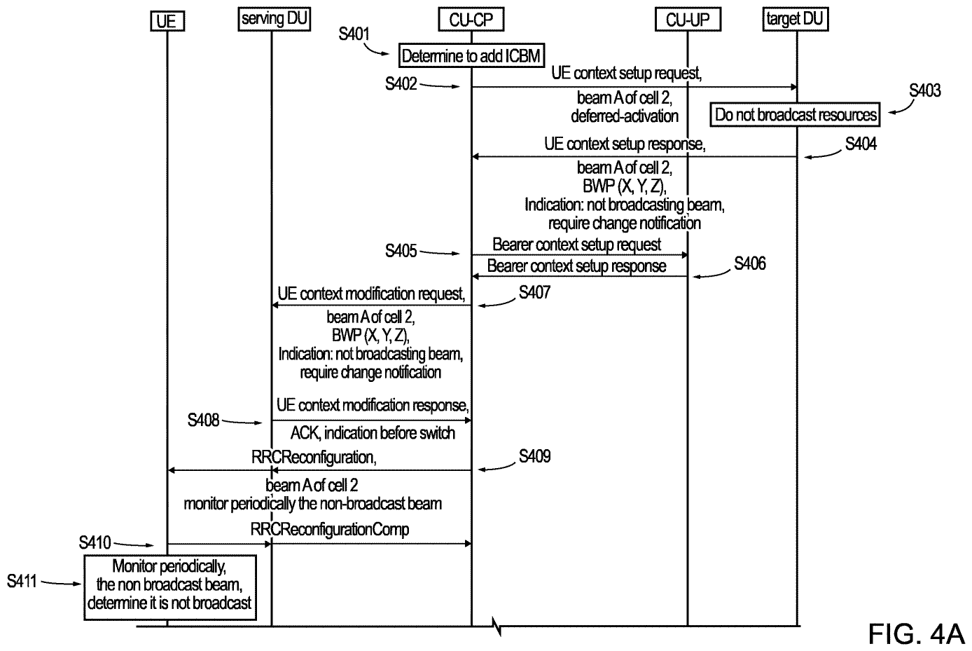

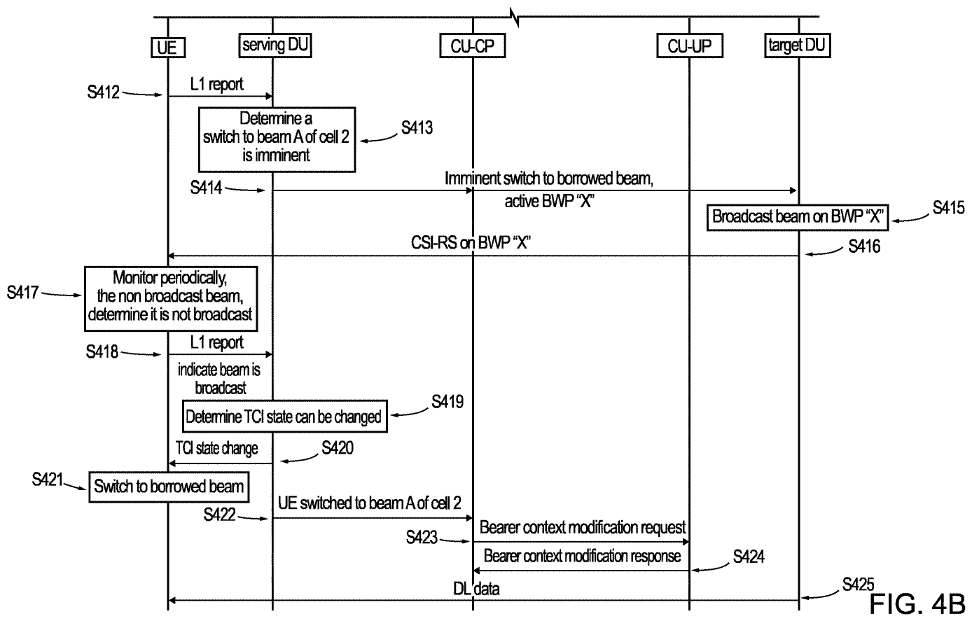

FIG. 4 schematically illustrates an example of a signaling/messaging flowchart according to example embodiments of the present disclosure. Notably, identical or like reference numbers and/or messages (as well as the contents comprised therein) used in FIG. 4 may, unless indicated otherwise, indicate identical or like elements and/or messages (and the respective contents therein), such that repeated description thereof may be omitted for reasons of conciseness.

Particularly, as can be seen from the figures, the example embodiment as shown in FIG. 4 is more or less the same as that in FIG. 3, except for those procedures/steps related to the UE side are now illustrated in more detail. To be more specific, as shown in FIG. 4, when sending the beam configuration to the UE, e.g., in the RRC Reconfiguration message (or the like) as exemplified in step S409 (similar to step S309 of FIG. 3), the CU may in addition also configure the UE (e.g., as part of the RRC Reconfiguration message or in any other suitable separate message) to monitor (e.g., periodically) the UE-specific RS, even though said UE-specific RS (e.g., CSI-RS). has been configured to be refrained from broadcasting by the target DU (e.g. in steps S302 or S402 where the CU-CP sends a UE context setup request to the target DU and indicates that this is for ICBM with “deferred-activation”).

In response to such configuration (related to monitoring), the UE may, in step S411, start (continuous) monitoring (e.g., periodically as configured) the beam of the target cell, and determine that the UE-specific RS (e.g., CSI-RS) is not broadcast on said beam, and report the corresponding measurement result to the serving DU in step S412.

Since the UE continuously and periodically monitors the beam of the target cell (though not explicitly reflected in the figure, but rather as two separate steps S411 and S417), once the target cell starts broadcasting the UE-specific RS (e.g., CSI-RS) on said beam (as exemplified in step S416, similar to step S316 of FIG. 3), the UE would determine, in step S417, that the UE-specific RS (e.g., CSI-RS) is now broadcast on said beam; and report accordingly to the serving DU in step S418.

The serving DU may then, based on such measurement report (particularly the indication contained therein), determine to change the TCI state at some point in time, as exemplified the step S419. The subsequent procedures/steps are essentially the same as those illustrated in FIG. 3, such that repeated description thereof may be omitted for reasons of conciseness.

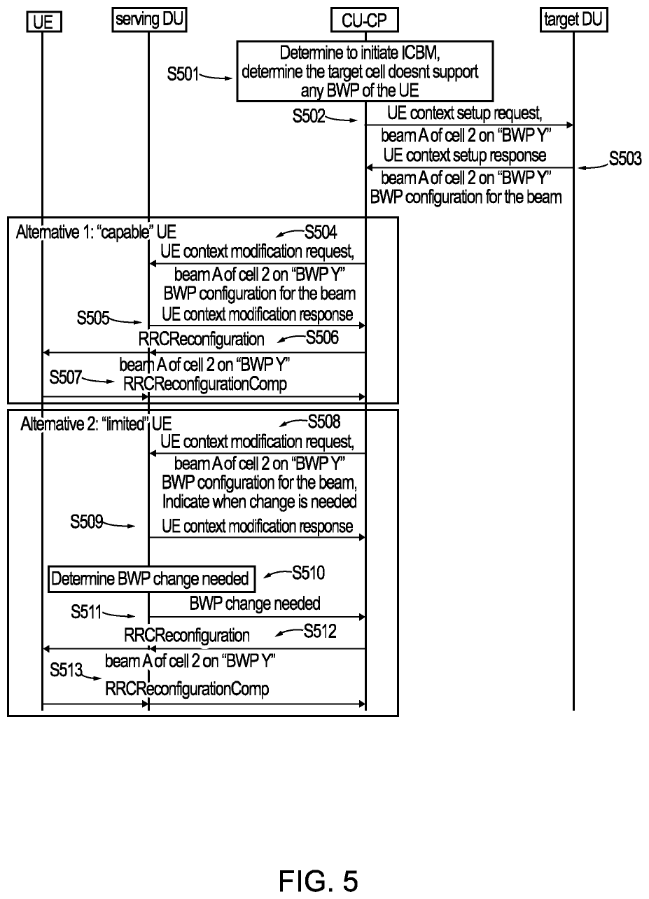

Reference is now made to FIG. 5, which schematically describes some further example embodiments that may (depending on various implementations) be used in conjunction with (at least partially) or as an alternative to the example embodiments as described above with reference to FIG. 3 and/or FIG. 4. That is to say, the example embodiments as will be described with reference to FIG. 5 do not necessarily rely on some or all the procedures as shown in FIG. 3/4, for instance in implementations addressing (only) the issue where the target DU may not support the BWP configurable by the source DU. Thus, it is to be understood that those procedures/steps as shown in FIG. 3/4 particularly with regard to configuring the target DU to refrain from broadcasting the UE-specific RS should not constitute any limitation on the example embodiments as shown in FIG. 5. Nevertheless, depending on various implementations, the example embodiments of FIG. 3/4 and FIG. 5 may as well be combined, as can be understood and appreciated by the skilled person. Notably, in this example embodiment as will be described in detail below, it is generally assumed that the source/serving cell (DU) and the target cell (DU) may each operate on (e.g., be configured with) or configurable with one or more BWPs. For example, the source cell may be currently configured with BWPs A, B and C; while the target cell may be currently configured with BWPs X, Y and Z.

In general, a DU is the owner of the BWP resources that it can provide to a UE. The CU may indicate a preference but it is the DU that finally provides the configuration. The low layer configuration is provided by the DU. The CU may indicate which low layer configuration shall (preferably) be provided by the DU. But it is up to the DU to comply with the information indicated by the DU. The CU may re-configure the UE using the low layer configuration provided by the DU. For example, the target DU determines to configure the UE with BWP Y. Then there are 2 options: (i) The target DU may use an indication from the CU to determine to configure the UE with BWP Y or, (ii) the target DU may determine to configure UE with BWP Y based on the current UE BWP configuration. The UE is later on configured by the CU to use the BWP of the target DU.

Specifically, in step S501, the CU-CP (or more generically, the CU) may determine to initiate the ICBM procedure for the cell of the target DU. Similar to step S301 in FIG. 3, the determination of the initiation of the ICBM procedure may be based on any suitable criteria, such as (but certainly not limited thereto): received UE measurements of the beam of the target DU, operation and maintenance configuration where the beam topology may already be known to the operator such that a RAN node would know the neighbor beam, etc. Furthermore, in step S501, the CU-CP (or CU) may also determine that the target cell bandwidth does not support at least one BWP of the UE that is configured or configurable by the serving cell. Alternatively, the CU-CP may determine that the target cell bandwidth does not support any BWP currently associated with the UE. Depending on various implementations and/or requirements, this determination may also be made based on any suitable criteria, such as (but certainly not limited to): overall network topology, (physical) functionality capability supported by the target DU, network load condition, etc.

Subsequently, in step S502, the CU-CP indicates to target DU, that a specific beam A of the target cell (cell 2) is required on a specific BWP Y. This indication may be sent for example through a UE context setup request message (or any other suitable message). In some possible implementations, the CU-CP may also indicate only the requested beam without indicating the specific BWP to be provided by the DU. It should be noted that the message of S502 may be a separate message or merged with messages S302 or S402 in FIGS. 3 and 4. In other words, messages S302 or S402 may be added with information on the specific BWP Y.

The target DU answers to this request in step S503 (e.g., as a UE context setup response or the like) indicating its complete BWP configuration (for the requested BWP Y), as this configuration cannot be provided by the source DU. At the same time, the target DU also indicates the beam allocated by the target cell. Similar as above, the message of S503 may be a separate message or merged with messages S304 or S404 in FIGS. 3 and 4. In other words, messages S304 or S404 may be added with information on the specific BWP Y. Put differently, the procedure of FIG. 5 may be considered an extension of the procedures shown in FIGS. 3 and 4 where configurations of source and target cells with different BWPs are taken care of.

Now, the CU-CP generally follows two alternatives depending on UE capabilities (indicated by using the wording “capable” and “limited” in FIG. 5). As can be understood and appreciated by the skilled person, such UE capability may be determined based on any suitable criteria, such as UE category configured by higher layers, (physical) functionality supported by the UE, etc. In a broad sense, it may be generally considered that, in the context of the example embodiment of FIG. 5, the “capable” UE may generally refer to a UE that is capable of being configured with (operating on) more than one BWP simultaneously; whist the “limited” UE may generally refer to a UE that can only be configured with a single BWP configuration at a time.

### Alternative 1: “Capable” UE

For this alternative, the CU-CP may indicate, in step S504 the BWP configuration of the target DU to the source/serving DU. In response, the source DU may incorporate said BWP configuration of the target DU (for example in the UE MAC configuration) and send it back to the CU-CP in step S505.

Subsequently, since the UE is capable of operating on more than one BWP simultaneously, the CU may simply configure (e.g., by sending an RRC Reconfiguration message or the like) the UE with the configuration allocated by the target DU and source DU (step S506); and in turn, the UE confirms the re-configuration (step S507). Put differently, it may be generally understood that, since the UE has the capability of being configured (and operating) on two or more BWPs at the same time, the exact timing (or triggering) for the CU to send the respective configuration message (e.g., an RRC Reconfiguration message or the like) is not that critical compared to Alternative 2 as will be described below. In some possible implementations, the RRC reconfiguration may also contain a measurement gap configuration, thereby facilitating the UE (by using such measurement gap configuration) to monitor the broadcast channels of the serving cell. Notably, as could be understood by the skilled person, in some cases (e.g., inter-frequency ICBM scenarios), a proper measurement gap configuration depending on the BWP UE is operating may be needed, since UE has to use this measurement gap to perform necessary L1 RSRP measurements.

### Alternative 2: “Limited” UE

In this alternative, steps S508-S509 are generally considered similar to steps S504-S505 in the above-illustrated Alternative 1, namely the CU-CP may indicate the BWP configuration of the target DU to the source DU (step S508) and the source DU may incorporate the BWP configuration of the target DU for example in the UE MAC configuration and send it back to the CU-CP (step S509), with a difference where the CU-CP may additionally configure (in step S508) the source DU to indicate when the UE should be re-configured with the new BWP configuration. More specifically, since the (“limited”) UE can only be configured with a single BWP configuration, the switch to the beam of the target DU and the BWP configuration generally have to happen at the same time. Put differently, compared to the above Alternative 1, in this alternative, the CU needs to know when to send the respective configuration message (e.g., an RRC Reconfiguration message or the like) to the UE, in order to ensure the proper operation of such a UE with “limited” capability.

After some time, the source DU may determine, in step S510, that the switch to the target cell beam is needed, for example based on the measurement reports sent by the UE to the source DU (not explicitly shown in the figure). Accordingly, as configured above, the source DU sends an indication to the CU in step S511, indicating that the BWP switch/change is needed now. Notably, as can be understood and appreciated by the skilled person such indication may be sent by using any suitable mechanism (e.g., in a suitable message).

Different from the above-illustrated Alternative 1, in this Alternative 2, only upon receipt of the indication that the BWP switch/change is needed (as sent in step S511), the CU may configure the UE with the configuration allocated by the target DU and source DU (step S512); and correspondingly the UE may acknowledge such re-configuration (step S513). Similar to above, in this Alternative 2, the RRC reconfiguration may also contain a suitable measurement gap configuration, thereby facilitating the UE (by using such measurement gap configuration) to monitor the broadcast channels of the serving cell.

To summarize the above, the example embodiment as described with reference to FIG. 5 may generally be seen as to address the issue where the target DU may not support any (or at least one) of the BWP(s) configurable by the source DU for the UE. In other words, there is a mismatch between the BWP that the UE is configured (by the source DU) and the available BWPs on the target DU. There are 3 possible cases: (i) The target cell bandwidth may be completely different than source cell bandwidth. (ii) The bandwidth parts of the UE provided by the serving cell may be on a separate bandwidth than the bandwidth of the target cell (so target cell and source cell bandwidth may overlap but it is not the case for the BWP of the UE, so it is a subcase of case 1.) (iii) One bandwidth part of the UE provided by the serving cell may be on a separate bandwidth than the bandwidth of the target cell (some bandwidth parts of the UE may be comprised by the target cell bandwidth, so this case is a subcase of case 2.)

To be more specific, in some possible example embodiments, the CU (or CU-CP) may determine to configure the UE with ICBM operation where the target cell operates in at least one BWP that is not part of the source cell bandwidth. The CU may determine to indicate which BWP the target cell should allocate the beam for ICBM operation of the UE. In other words, the CU determines a BWP that can be used by the target DU (the DU can be configured to) and used by the UE (the UE can be configured to) and instructs both to use this BWP. For example, the CU indicates to target DU that among all BWPs it can allocate to the UE, the target DU should allocate a specific preferred BWP “Y” (if possible). The CU also configures the UE with the BWP information of the target DU. The BWP that is not part of the bandwidth of the target cell or not fully overlapping with the bandwidth of the target cell is indicated from the target DU to the CU. Accordingly, the CU can use this information to configure the new BWP to the UE. This information is indicated to the target DU over the CU. As a result, the target DU can determine to switch to the BWP of the UE using this information. Configured as proposed above, UEs (“capable” or “limited”) are generally enabled to use ICBM even if the source and target Dus do not have a common BWP available.

As has been noted above, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the CU, the DU, etc.

It should nevertheless be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also to be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1-37. (canceled)

38. A first network node that supports at least one of central unit control plane, CU-CP, functionality or a layer 3 protocol of a radio access network, comprising:
at least one processor; and
at least one memory storing instructions that, when executed by the at least one processor, cause the first network node at least to:
determine to initiate an inter-cell beam management, ICBM, procedure involving at least a source cell of a second network node that supports at least one of distributed unit, DU, functionality or a layer 2 protocol of the radio access network, the source cell serving a user equipment, UE, and a target cell of a third network node that supports at least one of the DU functionality or the layer 2 protocol of the radio access network;
transmit a first request message to the third network node, wherein the first request message comprises information indicative of a beam of the target cell, and information for configuring the third network node to refrain from transmitting a UE-specific reference signal, RS; and
receive a first response message from the third network node, wherein the first response message comprises information indicative of a configuration of the beam for the ICBM procedure and information indicative of the third network node being configured to refrain from transmitting the UE-specific RS.

39. The first network node according to claim 38, wherein the first network node is further caused to:
transmit a second request message to the second network node, wherein the second request message comprises information indicative of the configuration of the beam and information indicative of the third network node being configured to refrain from transmitting the UE-specific RS; and
receive a second response message from the second network node, wherein the second response message comprises information indicative of an acknowledgement for the information indicative of the third network node being configured to refrain from transmitting the UE-specific RS.

40. The first network node according to claim 39, wherein the second request message further comprises information indicative of requesting transmission of a message indicating a switch of the UE to the beam of the target cell is to be expected; and
wherein the second response message further comprises information indicative of an acknowledgement for the information indicative of requesting transmission of a message indicating a switch of the UE to the beam of the target cell is to be expected.

41. The first network node according to claim 38, wherein the first network node is further caused to:
receive, from the second network node, a first indication message comprising information indicating that a switch of the UE to the beam of the target cell is to be expected; and
transmit a second indication message to the third network node for enabling the third network to start transmitting the UE-specific RS.

42. The first network node according to claim 41, wherein the first network node is further caused to:
receive, from the third network node, a third indication message comprising information indicative of transmission of the UE-specific RS; and
transmit a fourth indication message comprising information indicative of the transmission of the UE-specific RS by the third network node.

43. The first network node according to claim 38, wherein the determination to initiate the ICBM procedure is based on at least one of: a measurement report received from the UE, or a system operation and maintenance configuration.

44. The first network node according to claim 38, wherein the UE-specific RS comprises a channel state information reference signal, CSI-RS.

45. The first network node according to claim 38, wherein each of the source and target cells is configurable to operate in at least one bandwidth part, BWP; and
wherein the first network node is further caused to:
determine that the target cell does not support at least one BWP currently associated with the UE;
transmit a third request message to the third network node, wherein the third request message comprises information indicative of a beam on a BWP of the target cell; and
receive, from the third network node, a third response message comprising information indicative of a BWP configuration for the beam.

46. The first network node according to claim 45, wherein the first network node is further caused to:
determine whether the UE is capable of supporting more than one BWP simultaneously;
based on determining that the UE is capable of supporting more than one BWP simultaneously:
transmit a fourth request message to the second network node, wherein the fourth request message comprises information indicative of the BWP configuration for the beam; and
based on determining that the UE is not capable of supporting more than one BWP simultaneously:
transmit a fifth request message to the second network node, wherein the fifth request message comprises information indicative of the BWP configuration for the beam, and information for configuring the second network node to indicate when a switch to the beam of the target DU is to be expected.

47. The first network node according to claim 46, wherein the first network node is further caused to:
receive, from the second network node, a message comprising information indicative of the switch to the beam of the target DU is to be expected.

48. The first network node according to claim 46, wherein the first network node is further caused to:
transmit a configuration message comprising information indicative of the BWP configuration for the beam to the UE.

49. A second network node that supports at least one of distributed unit, DU, functionality or a layer 2 protocol of a radio access network and is configured with a source cell serving a user equipment, UE, comprising:
at least one processor; and
at least one memory storing instructions that, when executed by the at least one processor, cause the second network node at least to:
receive, from a first network node that supports at least one of central unit control plane, CU-CP, functionality or a layer 3 protocol of the radio access network, a first request message comprising information indicative of a configuration for a beam of a target cell of a third network node that supports at least one of the DU functionality or the layer 2 protocol of the radio access network, and information indicative of the third network node being configured to refrain from transmitting a UE-specific reference signal, RS; and
transmit a first response message to the first network node, wherein the first response message comprises information indicative of an acknowledgement for the information indicative of the third network node being configured to refrain from transmitting the UE-specific RS.

50. The second network node according to claim 49, wherein the second network node is further caused to:
determine that a switch of the UE to the beam of the target cell is to be expected; and
transmit a first indication message comprising information indicative of the to be expected switch to the first network node.

51. The second network node according to claim 50, wherein the second network node is further caused to:
receive a first measurement report from the UE, wherein the determination that a switch of the UE to the beam of the target cell is to be expected is based on the first measurement report.

52. The second network node according to claim 50, wherein the second network node is further caused to:
receive, from the first network node, a second indication message comprising information indicative of transmission of the UE-specific RS by the third network node.

53. The second network node according to claim 51, wherein the second network node is further caused to:
receive, from the UE, a second measurement report;
determine to switch the UE to the beam of the target cell based on the second measurement report; and
transmit a message comprising information indicative of a transmission configuration indication, TCI, state change corresponding to the target cell to the UE.

54. The second network node according to claim 49, wherein each of the source and target cells is configurable to operate in at least one bandwidth part, BWP, wherein the second network node is further caused to:
receive, from the first network node, a second request message comprising information indicative of a BWP configuration for the beam of the target cell.

55. The second network node according to claim 49, wherein each of the source and target cells is configurable to operate in at least one bandwidth part, BWP, wherein the second network node is further caused to:
receive, from the first network node, a third request message comprising information indicative of a BWP configuration for the beam of the target cell and information indicative of a configuration for the second network to indicate when a switch to the beam of the target DU is to be expected.

56. The second network node according to claim 55, wherein the second network node is further caused to:
determine that a switch to the beam of the target DU is to be expected; and
transmit a third indication message comprising information indicating that the switch to the beam of the target DU is to be expected to the first network node.

57. A third network node that supports at least one of distributed unit, DU, functionality or a layer 2 protocol of a radio access network, comprising:
at least one processor; and
at least one memory storing instructions that, when executed by the at least one processor, cause the third network node at least to:
receive, from a first network node that supports at least one of central unit control plane, CU-CP, functionality or a layer 3 protocol of the radio access network, a first request message comprising information indicative of a beam of a target cell of the third network node, and information for configuring the third network node to refrain from transmitting a UE-specific reference signal, RS;
configure the third network node to refrain from transmitting UE-specific RS; and
transmit a first response message to the first network node, wherein the first response message comprises information indicative of the third network node being configured to refrain from transmitting the UE-specific RS.

58. The third network node according to claim 57, wherein the third network node is further caused to:
receive, from the first network node, a first indication message comprising information indicating that a switch of a user equipment, UE, served by a source cell of a second network node that supports at least one of the DU functionality or the layer 2 protocol of the radio access network to the beam of the target cell is to be expected;
start transmitting the UE-specific RS; and
transmit a second indication message comprising information indicative of an acknowledgement for the to be expected switch to the first network node.

59. The third network node according to claim 57, wherein the UE-specific RS comprises channel state information, CSI, related RS.

60. The third network node according to claim 57, wherein the target cell is configurable to operate in at least one bandwidth part, BWP.

61. The third network node according to claim 60, wherein the third network node is further caused to:
receive, from the first network node, a second request message comprising information indicative of a beam on a BWP of the target cell; and
transmit a second response message comprising information indicative of a BWP configuration for the beam to the first network node.

62. A, user equipment, UE, comprising:
at least one processor; and
at least one memory storing instructions that, when executed by the at least one processor, cause the UE at least to:
receive, from a first network node that supports at least one of central unit control plane, CU-CP, functionality or a layer 3 protocol of the radio access network, a configuration message comprising information indicative of a beam of a target cell of a third network node that supports at least one of distributed unit, DU, functionality or a layer 2 protocol of the radio access network, and information indicative of the third network node being configured to refrain from transmitting a UE-specific reference signal, RS;
monitor the UE-specific RS; and
based on determining that the UE-specific RS is broadcast, transmit a message comprising information indicative of the UE-specific RS being broadcast to a second network node that supports at least one of the DU functionality or the layer 2 protocol of the radio access network.
